(19) United States
(12) Patent Application Publication
(10) Pub. No.: US 2017/0050800 A1
(43) Pub. Date: Feb. 23, 2017

(54) CONTAINER

(71) Applicant: AWESOME BRANDS LTD., Dublin (IE)

(72) Inventor: Simon GAIN, Dublin (IE)

(21) Appl. No.: 15/306,706

(22) PCT Filed: Apr. 24, 2015
(86) PCT No.: PCT/EP2015/058995

§ 371 Date: Oct. 25, 2016

(30) Foreign Application Priority Data
Apr. 25, 2014 (GB) 1407352.2

(51) Int. Cl. B65D 85/816; A45F 3/20; B29C 49/06; B65B 5/02; B29B 11/08; B65D 21/08; B65B 7/28

(52) U.S. Cl. CPC B65D 85/816; B65D 21/086; A45F 3/20; B65B 7/28; B65B 5/02; B29B 11/08; B29C 49/06; A45F 2003/205; B29L 2031/712

(57) ABSTRACT

A container 401 comprising: a base 402; and a sidewall 404 extending from the base 402; wherein the base 402 and the sidewall 404 define a cavity for containing a consumable; the sidewall 404 comprising at least in part a sidewall element 406 deformable between a compressed state in which the cavity has a first volume and an uncompressed state in which the cavity has a second volume; the sidewall element 406 configured to be bistable such that the sidewall element 406 will remain at rest in equilibrium in both the compressed state and the uncompressed state; wherein the sidewall element 406 is movable between the compressed and uncompressed states by input of an activation energy to the container 401.

The present invention relates to a container for a consumable. In particular, the present invention relates to a container for a hydratable consumable.

It is common practice for certain consumables to be supplied in a dry or hydratable form, i.e. a form in which water needs to be added to the consumable to obtain a usable product. Such consumables can include dried soup, dried pasta, dried noodles, dried rice, dried ready meals, pharmaceuticals, medicines, freeze-dried coffee, tea, hot chocolate, soft drinks, energy drinks, malted drinks, powdered desserts such as custard, blancmange, jellies and mousses, neutraceutical health products, vitamins, breakfast cereals, vending packs, third world supplies, dental health products, hair and beauty products, baby formula etc.

An advantage of supplying such consumables in a hydratable form is that it saves weight and reduces the volume of the consumable. This makes the consumable easier and cheaper to transport and also increases the shelf-life of the consumable as dried products deteriorate more slowly and are less susceptible to bacterial or fungal attack.

Containers for packaging such consumables are known. In addition, containers for packaging such consumables, which allow water to be added to the container to hydrate the consumable in situ are also known. Such containers have a relatively large volume compared to the volume of packaged consumable, i.e. the consumable occupies only a small proportion of the volume of the container. This is to allow for an increase in volume as the consumable is hydrated to create a usable product. The extra space such containers provide is only used at the point of consumption. The remainder of the time such space is of no use. The increased volume of such containers is a disadvantage because it reduces the number of containers which can be transported in a given space or stocked on a shop shelf.

The applicant sought to address the foregoing problems in their co-pending UK Patent Application No. GB 1407352.2. In general outline, this earlier application discloses a container comprising: a base; and a sidewall extending from the base; wherein the base and the sidewall define a cavity for containing a consumable; the sidewall comprising at least in part a sidewall element resiliently deformable between a compressed state in which the cavity has a first volume and an uncompressed state in which the cavity has a second volume; the sidewall element being configured to remain in the compressed state under influence of a retaining force applied to the container and automatically return to its uncompressed state when the retaining force is removed; and wherein the sidewall tapers outwards as it extends from the base. A container having a resiliently deformable sidewall element means that the sidewall element can be compressed when the container is being stored, transported or displayed in order to save space and then expanded at the point of consumption so that the consumable can be hydrated within the larger uncompressed volume of the container. Having a sidewall which tapers outwards as it extends from the base allows the container to collapse within itself as it is compressed. Additionally, it gives the container the qualities of a cup or bowl and aids consumption from the container.

The sidewall element may be compressible so that the height of the container is reduced in the compressed state compared to the uncompressed state. In particular, the sidewall element may be axially compressible.

The sidewall element may comprise a bellows-like structure, the bellows-like structure comprising alternating inwardly extending folds and outwardly extending folds connected by fold elements. A bellows-like structure is an efficient and reversible way of collapsing the sidewall of the container.

Optionally, each outwardly extending fold may be configured such that it fits within the outwardly extending fold above it and each inwardly extending fold is configured such that it fits within the inwardly extending fold above it. This further aids the container to collapse within itself as it is compressed.

An inner angle between adjacent fold elements in each pair of fold elements forming an outwardly extending fold of the bellows-like structure may be in the range of 80° to 100° when the bellows-like structure is in the uncompressed state. The angle subtended by the fold elements contributes to the way in which the bellows-like structure folds. This range of angles has been found to result in an efficient and compact folded configuration of the bellows-like structure in its compressed state and further aids the container to collapse within itself as it is compressed.

Optionally, the inner angle described above may be 87.5°. This angle has been found to be particularly conducive to producing an efficient and compact folded configuration of the bellows-like structure in its compressed state and further aids the container to collapse within itself as it is compressed.

Each outwardly extending fold may be configured to fold within the outwardly extending fold above it and each inwardly extending fold is configured to fold within the inwardly extending fold above it. This provides a space efficient folded configuration of the bellows-like structure in its compressed state and results in particularly compact container when in the compressed state.

Optionally, the bellows-like structure may be configured to fold within the cavity. This means that the bellows-like structure does not extend outside the original dimensions of the container in its uncompressed state and results in an efficient and compact folded configuration of the bellows-like structure in its compressed state.

The bellows-like structure may be configured to extend inwardly into the cavity in its compressed state in a direction transverse to the direction in which the bellows-like structure extends in its uncompressed state. This is counter to a conventional bellows which fold in a direction parallel to the direction of compression and to the direction the bellows extend in in an uncompressed state. This configuration further reduces the height of the bellows-like structure in the compressed state and further contributes to an efficient and compact folded configuration of the bellows-like structure in its compressed state.

Optionally, the fold elements may abut each other in the compressed state. This reduces wasted space between the fold elements.

The outwardly extending folds and inwardly extending folds of the bellows-like structure may be configured to assume a concentrically nested arrangement in the compressed state. This further reduces wasted space between the fold elements.

The whole of the sidewall may comprise the sidewall element. This allows the container to be compressed to a virtually flat configuration.

Optionally, a first portion of the sidewall may comprise the sidewall element and a second portion of the sidewall together with the base may define a base cavity for containing a consumable. The base cavity provides an uncompressed volume for holding a predetermined amount of consumable.

The sidewall element may be made from a resilient material. This provides a resiliently deformable sidewall element.

The container may comprise a closure for closing an opening defined by an edge of the sidewall opposite the base, wherein the closure may form an air-tight seal when attached to the container. An air-tight seal allows a vacuum to be created in the cavity of the container.

Optionally, the closure may comprise a metal foil and a thermoweldable material. A metal foil provides a strong and gas impervious closure and a thermoweldable material allows the closure to be heat sealed to the container. Consequently, the closure may be attached to the container by heat sealing.

The retaining force may comprise a vacuum formed by the closure being attached to the container when the sidewall element is in the compressed state. This maintains the container in the compressed state until the closure is opened. Furthermore, a vacuum reduces the amount of oxygen in the container which helps to preserve its contents and prolong the shelf-life of the consumable.

Optionally, an edge of the sidewall opposite the base may comprise a lip configured to provide an attachment surface for the closure. A lip increases the surface area for attachment compared to a bare edge.

An edge of the sidewall opposite the base may further comprise at least one lug. A lug can be gripped by a user in order to keep their fingers away from the sidewall of the container which may be hot.

Optionally, the lip may be smooth to facilitate drinking from the lip. Features such as screw threads can roughen the surface around the opening of a container which makes it more difficult to drink from the container.

The lip may have a wall thickness of 0.25 to 0.80 mm. This has been found to be a comfortable thickness for a user to drink from the container.

Optionally, the closure further may comprise a tab part, the tab part extending over at least a part of the lug when the closure is attached to the container, the tab part being arranged to be gripped to remove the closure from the opening. This provides a convenient way of removing the closure.

The container may be made from a heat resistant material. This allows hot drinks to be made in the container and also for the container to be microwavable.

Optionally, the container may be made from a compound comprising polypropylene or low density polyethylene. Furthermore, the compound from which the container is made may further comprise a propylene based elastomer. This allows the elastic properties of the material to be enhanced. In addition, the compound from which the container is made may further comprise ethylene vinyl alcohol copolymer (EVOH). This acts as an oxygen barrier helping to preserve the contained consumable and prolonging shelf-life.

The container may have a wall thickness of 0.275 to 0.80 mm. This range has been found to provide the container with the required rigidity to act contain a hydrated consumable but also the required elastic deformability.

Optionally, the container may comprise a secondary closure arranged to protect the closure.

The earlier application also discloses a method of containing a consumable, the method comprising: providing a container according to any of the preceding paragraphs; placing a predetermined amount of a consumable in the container; compressing the container so that the container adopts a compressed state; closing the container with a closure while the container is in the compressed state, the closure providing an air-tight seal between the container and the closure. This method allows the volume required for containing a consumable to be reduced whilst the container is being stored, transported or displayed in order to save space. The container can then be expanded by breaking the seal at the point of consumption so that the consumable can be hydrated within the larger uncompressed volume of the container.

Despite the advantages provided by the applicant's earlier container, it may be improved. Firstly, the container has to be compressed during the production process and held in the compressed state during the filling and closing steps. This requires a considerable amount of force, particularly in the case where the sidewall element is made from a resilient material. Furthermore, the container has to be held in the compressed state by a clamp, with generally the same clamp having to be used for both the filling and closing steps. This may constrain the manufacturing process and make a high volume production line more complicated and challenging to implement.

Secondly, if the retaining force is compromised, for example, the air-tight closure maintaining the vacuum is damaged, then the container will automatically start to return to the uncompressed state. Clearly this will create problems if the container is not yet ready for use, for example, if it is being transported or is being stocked on a supermarket shelf.

Aspects and embodiments of the present invention were devised with the foregoing in mind.

According to a first aspect of the present invention, there is provided a container comprising: a base; and a sidewall extending from the base; wherein the base and the sidewall define a cavity for containing a consumable; the sidewall comprising at least in part a sidewall element deformable between a compressed state in which the cavity has a first volume and an uncompressed state in which the cavity has a second volume; the sidewall element configured to be bistable such that the sidewall element will remain at rest in equilibrium in both the compressed state and the uncompressed state; wherein the sidewall element is movable between the compressed and uncompressed states by input of an activation energy to the container. Having a sidewall element that is stable in both the compressed and uncompressed states means that the sidewall will remain in the compressed state without the need to apply a retaining force to the container until a threshold activation energy is input to the container by a user and will also stably remain in the uncompressed state once returned to the uncompressed state. In other words, once compressed the container will stay compressed and once returned to the uncompressed state the container will stay in the uncompressed state. As a result there is no need to keep the container clamped in the compressed state during the filling and closing steps of the production process and there is a reduced risk of the container unintentionally returning to the uncompressed state should the closure be compromised. It will be understood that there is no requirement for the container to be fully uncompressed or for every component part of the sidewall element to be uncompressed in order for the container to be in a stable state.

The sidewall element may be compressible so that the height of the container is reduced in the compressed state compared to the uncompressed state. In particular, the sidewall element may be axially compressible.

Optionally, the bistability may be provided by the sidewall element comprising an over centre arrangement. An over centre arrangement or mechanism provides a mechanical means of implementing a bistable system.

The sidewall element may comprise a bellows-like structure, the bellows-like structure comprising alternating inwardly extending folds and outwardly extending folds connected by fold elements. A bellows-like structure is an efficient and reversible way of collapsing the sidewall of the container.

Optionally, the bellows-like structure may comprise the over-centre mechanism. This allows the over centre mechanism to directly control the bellows-like structure and hence the compressed and uncompressed states of the container.

The over-centre mechanism may comprise at least one pair of adjacent fold elements of the bellows-like structure which are non-linear. In particular, the at least one pair of adjacent fold elements of the bellows-like structure may be curved. A curve provides a continuous non-linear structure which has a natural peak for the over centre mechanism and additionally is formable by moulding.

Optionally, the curve of one of the curved fold elements of the at least one pair of adjacent fold elements may have a shorter chord length than the curve of the other one of the curved fold elements of the at least one pair of adjacent fold elements. A shorter chord length means that the compressive force compressing the container is concentrated in this shorter curve meaning that this curve goes over centre in preference to the other one of the curved fold elements of the at least one pair of adjacent fold elements.

The one of the curved fold elements of the at least one pair of adjacent fold elements having a curve of shorter chord length may be substantially W-shaped and the other of the curved fold elements of the at least one pair of adjacent fold elements may have a substantially lazy S shape. This shape naturally has two curves between its two endpoints which have shorter chord lengths compared to the chord length of a single curve formed between the two endpoints.

Optionally, adjacent pairs of fold elements forming the outwardly extending folds are spaced apart at the inwardly extending folds. This provides a gap between adjacent pairs of fold elements forming the outwardly extending folds so that the fold element that has gone over centre can be accommodated in the gap.

The sidewall may be movable between the compressed state and uncompressed state by manually applied activation energy and vice versa. This allows for manual control of the expansion and compression of the container.

A resilience of the sidewall element may be configured such that the container automatically returns to its uncompressed state from its compressed state following input of an initial activation energy to the container. This reduces the effort that has to be expended by a user.

Alternatively, a resilience of the sidewall element may be configured such that further energy has to be applied to the container to return the container to its uncompressed state from its compressed state following input of an initial activation energy to the container. This allows a user to control the return of the container to its uncompressed state and the degree of expansion.

Optionally, the sidewall comprises first and second portions which define first and second portions of the cavity respectively, wherein the first portion of the sidewall is not compressible during normal operation of the container and wherein the second portion of the sidewall comprises the sidewall element. The second portion of the sidewall provides an uncompressed volume for holding a predetermined amount of consumable.

The first portion of the sidewall may be located near an edge of the sidewall opposite the base. This provides a non-compressible part of the container near its top which can be grasped by a clamp or a user.

Optionally, the first portion and second portion may have different wall thicknesses. In particular, the wall thickness of the first portion may be thicker than the wall thickness of the second portion. By making the wall thickness of the first portion thicker this provides more rigidity to this portion of the sidewall and prevents it being compressed during normal operation. By making the wall thickness of the second portion thinner, i.e. the portion which comprises the bellows-like structure, this can be made more flexible and deformable than the remainder of the sidewall which should be more rigid.

The wall thickness of the first portion may be between 0.6 and 1.0 mm. This has been found to provide a suitably rigid first portion.

Optionally, the wall thickness of the second portion may be between 0.1 and 0.3 mm. This has been found to provide a suitably flexible and deformable second portion.

An edge of the sidewall opposite the base may define an opening, the container further comprising a closure for closing the opening. This allows the container to be filled from above, for example, by a gravity-fed hopper and then closed for storage and transport.

According to a second aspect of the present invention there is provided a method of manufacturing a container according to any one of the preceding paragraphs, the method comprising: forming a preform by injection moulding; and blow moulding at least a part of the preform to produce the container. By using a two stage manufacturing process, different properties can be imparted to different parts of the container.

The preform forming step may comprise injection moulding a first portion of a sidewall of the container, the first portion of the sidewall not being compressible during normal operation of the container. This allows a first portion of the sidewall to be given a thicker wall thickness to provide it with increased rigidity compared with the remainder of the sidewall of the container.

Optionally, the preform forming step may further comprise injection moulding the base of the container. This allows the base to also be given a thicker wall thickness.

The blow moulding step may comprise blow moulding the preform to form a second portion of the sidewall, the second portion of the sidewall comprising a sidewall element which is deformable between a compressed state and an uncompressed state. This allows the second portion of the sidewall to be given a thinner wall thickness to make it more deformable compared to the first portion of the sidewall.

In particular, the blow moulding step may comprise blow moulding a bellows-like structure. This is one way of providing a deformable structure to allow the container to be compressed and uncompressed.

Optionally, the method may comprise forming the first and second portions of the sidewall with different sidewall thicknesses. This provides for the advantageous properties discussed above.

According to a third aspect of the present invention, there is provided a method of containing a consumable, the method comprising: providing, a container according to any one of the preceding claims; compressing the container so that the container adopts a compressed state; placing a predetermined amount of a consumable in the container; closing the container with a closure. This method allows the volume required for containing a consumable to be reduced whilst the container is being stored, transported or displayed in order to save space. The container can then be expanded by breaking the seal at the point of consumption so that the consumable can be hydrated within the larger uncompressed volume of the container.

Optionally, the method of the third aspect of the present invention may be immediately preceded by the method of the second aspect of the present invention such that the method of manufacturing a container and the method of containing a consumable are carried out as part of a single continuous production process. This provides for a highly integrated and fast and efficient manufacturing process.

One or more embodiments in accordance with the present invention will now be described, by way of example only, and with reference to the accompanying drawings, in which:

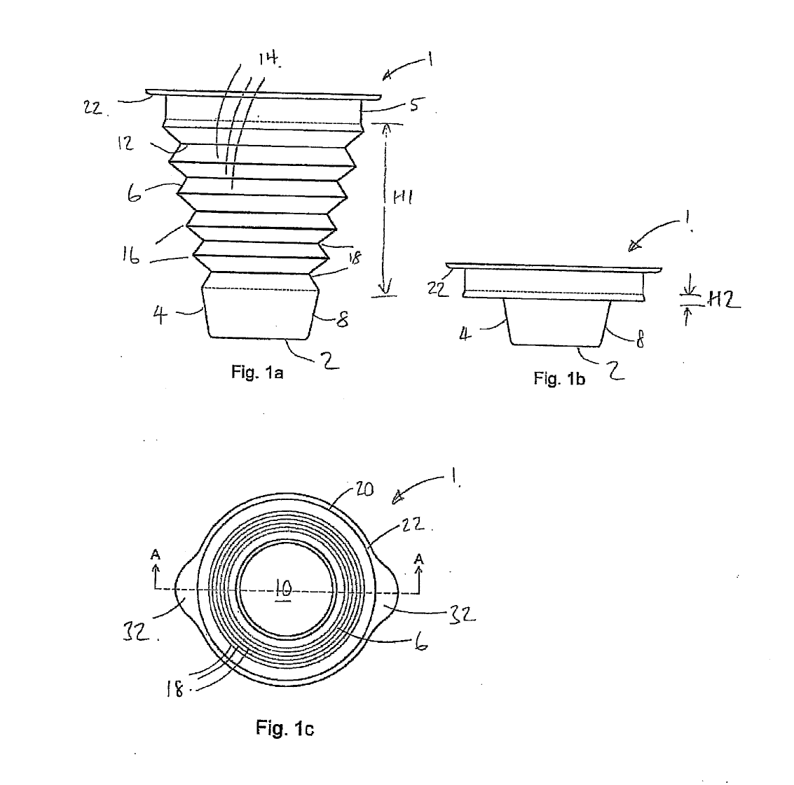

FIG. 1a is a side elevation view of a container.

FIG. 1b is a side elevation view of the container of FIG. 1a in a compressed state.

FIG. 1c is a plan view of the container of FIG. 1a.

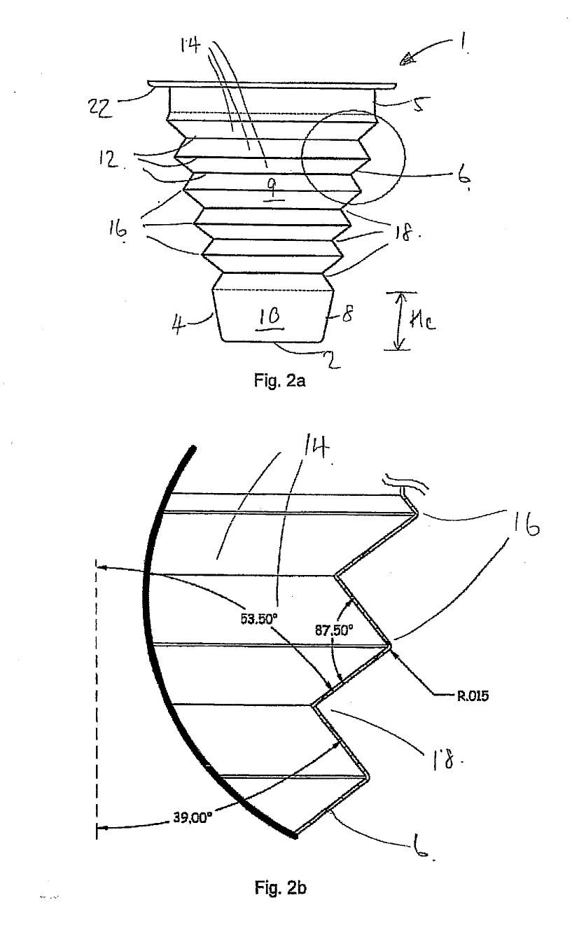

FIG. 2a is side elevation cross-sectional view of the container of FIG. 1a.

FIG. 2b is a magnified view of the part of the container encircled in FIG. 2a.

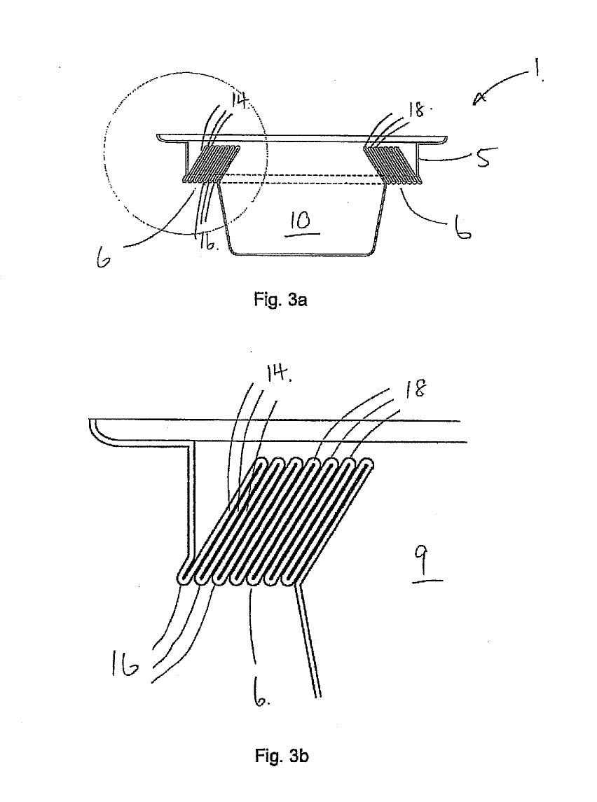

FIG. 3a is side elevation cross-sectional view of the container of FIG. 1a in a compressed state taken along the line A-A in FIG. 1c.

FIG. 3b is a magnified view of the part of the container encircled in FIG. 3a.

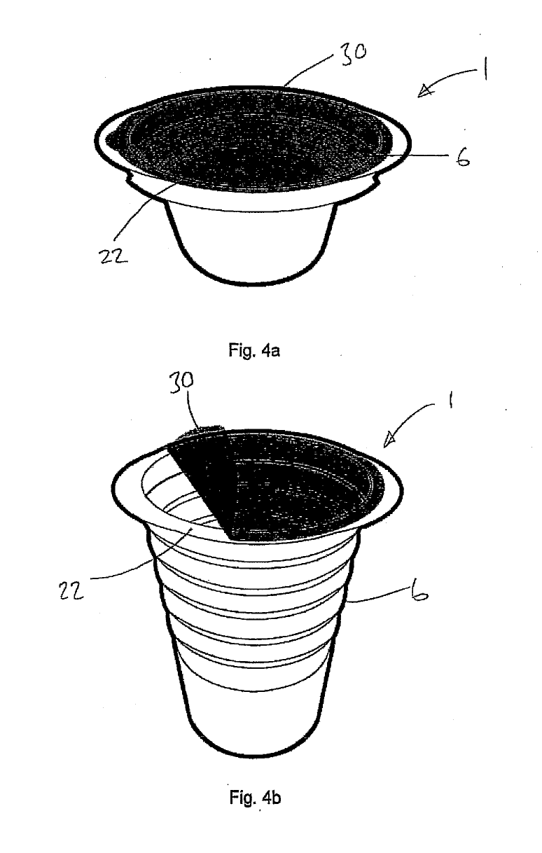

FIG. 4a is a perspective view of the container of FIG. 1a in a compressed state in which the container is closed by a closure.

FIG. 4b is a perspective view of the container of FIG. 1a in an uncompressed state in which the closure has been partly removed from the container.

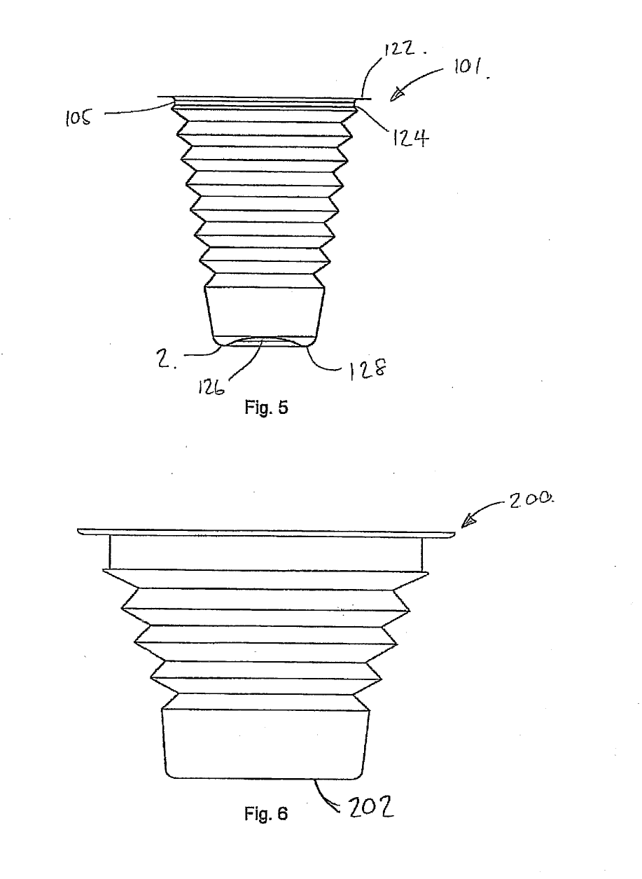

FIG. 5 is a side elevation cross-sectional view of a second container.

FIG. 6 is a side elevation view of a third container.

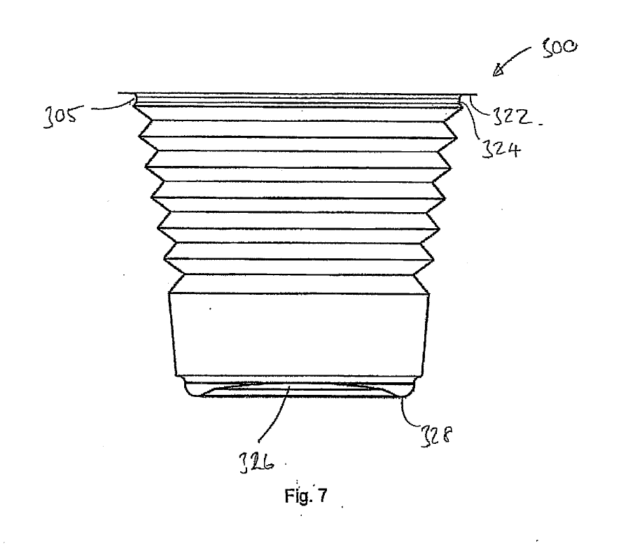

FIG. 7 is a side elevation cross-sectional view of a fourth container.

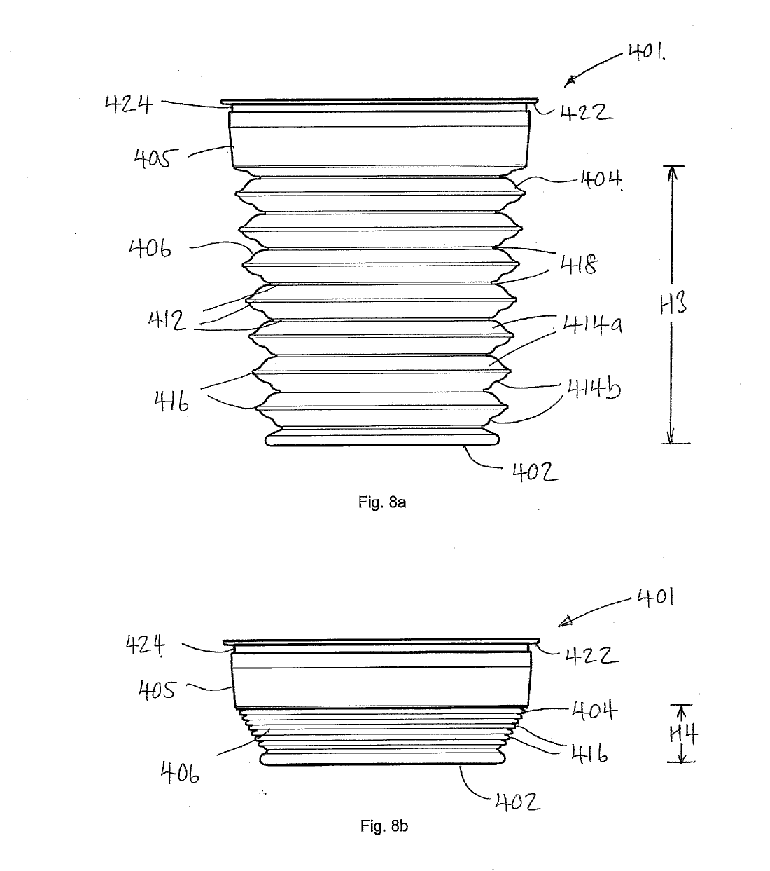

FIG. 8a is a side elevation view of a container according to an embodiment of the invention.

FIG. 8b is a side elevation view of the container of FIG. 8a in a compressed state.

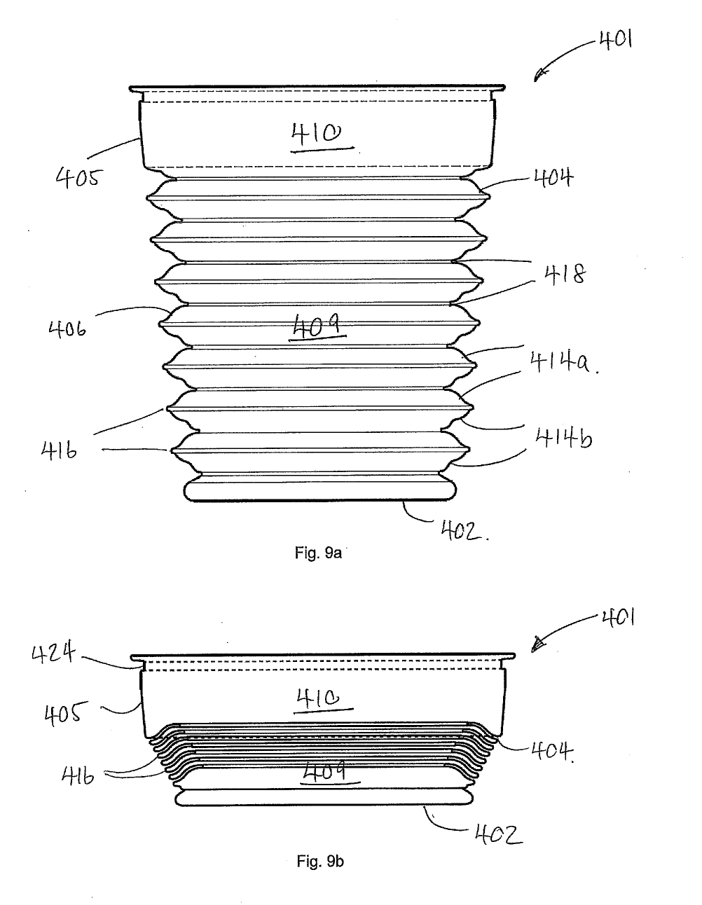

FIG. 9a is side elevation cross-sectional view of the container of FIG. 8a taken along a diameter of the container.

FIG. 9b is side elevation cross-sectional view of the container of FIG. 8a in a compressed state taken along a diameter of the container.

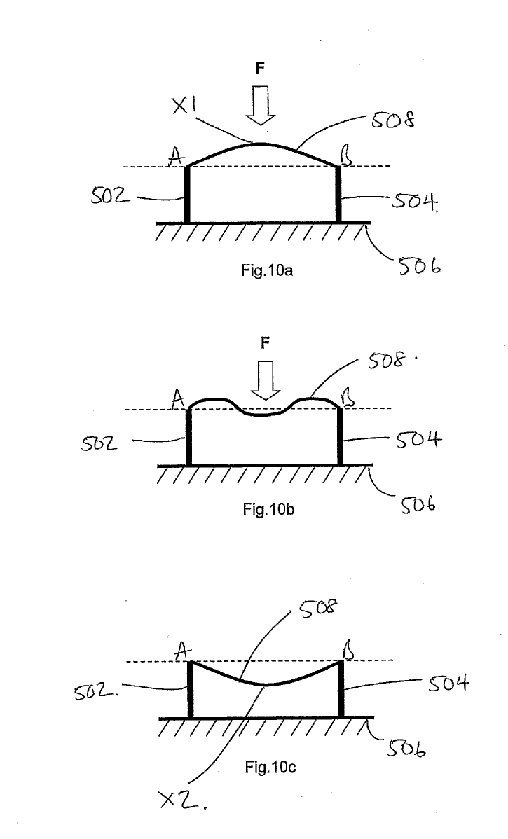

FIGS. 10a-c are schematic views of an over centre mechanism in its various stages of operation.

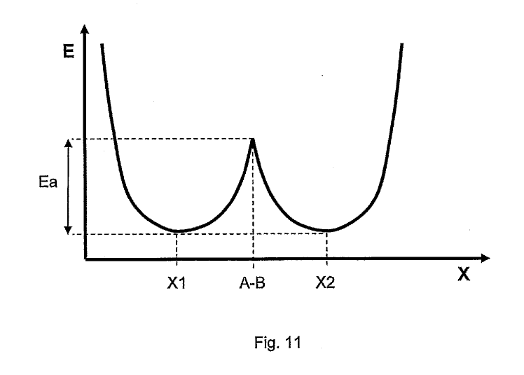

FIG. 11 is a graph of energy E against displacement X of the curved element of FIGS. 10a-c.

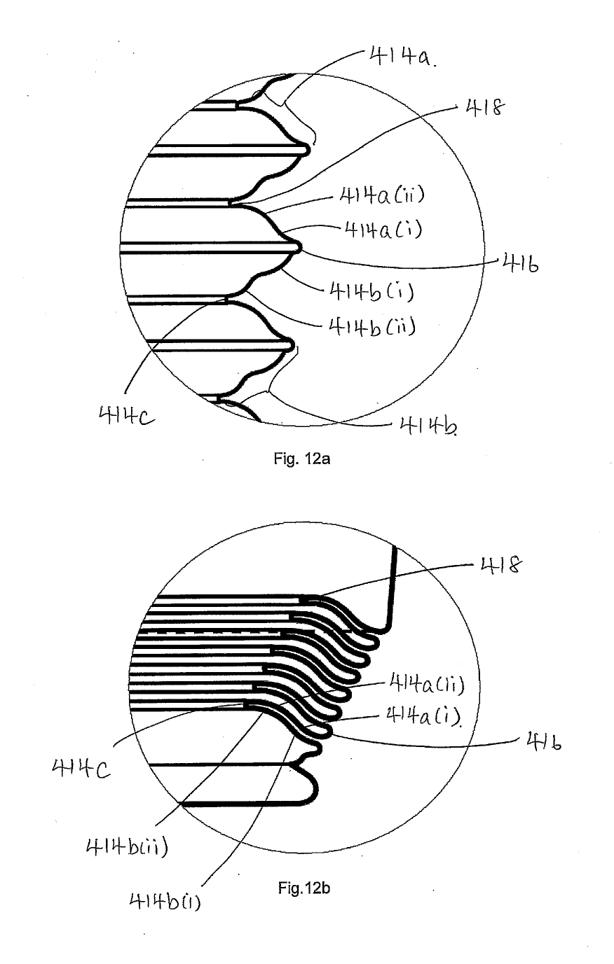

FIG. 12a is a magnified cross-sectional view of part of the uncompressed container shown in FIG. 9a.

FIG. 12b is a magnified cross-sectional view of part of the compressed container shown in FIG. 9b.

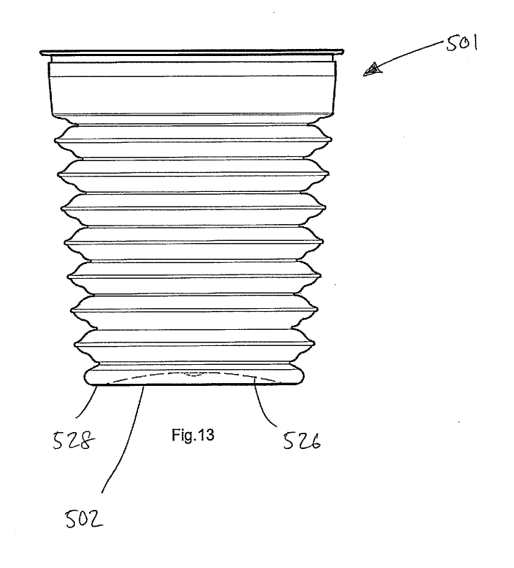

FIG. 13 is a side elevation view of a container according to a second embodiment of the invention.

FIG. 1 a shows a cup 1 to the applicant's novel design having a base 2 and a sidewall 4 extending upwardly away from the base 2. The base 2 and sidewall 4 define a cavity (not shown but see reference 9 in FIG. 2a) for containing a consumable. An upper portion of the sidewall 4 comprises a collar 5. An intermediate portion of the sidewall 4 comprises a resiliently deformable sidewall element, which is concertina-shaped and has the form of a bellows 6. A lower part 8 of the sidewall 4 together with the base 2 defines a base cavity (not shown but see reference 10 in FIG. 2a) which can be used to contain a hydratable consumable (not shown).

The bellows 6 is elastically deformable between an uncompressed state, as shown in FIG. 1a, and a compressed state, as shown in FIG. 1b. The bellows 6 is compressed by the application of a compressive force in a direction parallel to the longitudinal axis of the cup 1 towards the base 2. In the uncompressed state the bellows 6 has a height H1 corresponding to a first volume of the bellows. In the compressed state the bellows 6 has an effective height H2, which is less than height H1 and corresponds to a second volume of the bellows 6. The second volume of the bellows 6 is considerably less than the first volume. The reduction in volume will depend on the height Hc of the base cavity 10 (see FIG. 2a) and the number of bellows.

The bellows comprise a series of fold-lines 12 in the material of the cup 1 which create a series of fold elements 14. Pairs of fold elements 14 create a series of alternating outwardly extending folds 16 and inwardly extending folds 18. The outwardly extending folds 16 and inwardly extending folds 18 are annular in shape. As the bellows 6 is compressed towards the base 2, the fold elements 14 fold about the fold-lines 12 such that the angle between the fold elements 14 decreases until they abut each other. The effective height H2 constitutes the height H1 of the bellows 6 in the uncompressed state less the reduction in height of the bellows 6 as the bellows 6 are compressed into the compressed state. Viewed from the outside of the cup 1, height H2 appears to be less than the width of the angled fold elements 14. This is because at least a part of each of the fold elements 14 folds up inside the collar 5 (see FIG. 3a) and this is explained below.

The sidewall 4 of the cup 1 tapers outwardly as it extends away from the base 2. The sidewall 4 including the bellows 6 tapers such that each successive outwardly extending fold 16 is just wider, i.e. has a larger diameter, than the outwardly extending fold 16 below it such that each outwardly extending fold 16 fits within the next outwardly extending fold 16 above it, i.e. in a direction of increasing cross-section of the cup 1. Likewise, each successive inwardly extending fold 18 has a larger diameter than the inwardly extending fold 18 below it such that each inwardly extending fold 16 fits within the next inwardly extending fold 16 above it, i.e. in a direction of increasing cross-section of the cup 1. Each outwardly extending fold 16 and each inwardly extending fold 18 is able to fold within the respective outwardly extending fold 16 and inwardly extending fold 18 above it as the bellows 6 is collapsed. The difference in diameters between the successive outwardly extending folds 16 and inwardly extending folds 18, and hence the taper of the cup 1, allows for the wall thickness of the folded material of the cup 1 and also various manufacturing tolerances.

An upper edge of the sidewall 4 of the cup 1 has a lip 22 extending transversely away from the collar 5. The lip 22 provides an attachment surface for a closure (not shown). The lip 22 is smooth and the outer edge of the lip 22 curves upwards to assist a user in drinking from the cup 1

FIG. 1c shows the inside of the cup 1 from above. The cup 1 has an opening 20 defined by an upper edge of the sidewall 4. The lip 22 which surrounds opening 20 provides an annular attachment surface for a closure (not shown). The diameter of successive inwardly projecting annular troughs 18 of the bellows 6 decrease towards the base cavity 10 and appear as a series of concentric rings in plan view.

The upper edge of the sidewall 4 also has two lugs 32 transversely extending away from the sidewall 4 and arranged in diametrically opposed positions. The lugs 32 assist with stability and comfort when holding warm drinks. For example, the cup 1 can be balanced on the lugs 32 and gripped by the lugs 32 when a hot liquid is in the cup to keep a user's fingers away from the hot sidewall 4 of the cup 1.

FIG. 2a shows a side elevation cross-section through the cup 1. The sidewall 4, including the portions of the sidewall 4 comprising the collar 5, bellows 6 and lower part 8, together with the base 2 define a cavity 9 for containing a consumable. In particular, the cavity is suitable for containing a consumable in a usable condition, for example, once a volume of water has been added to a hydratable consumable to form a hydrated consumable such as a drink. The lower part 8 of the sidewall 4 together with the base defines a base cavity 10 for containing the consumable in its hydratable form. The base cavity 10 has a smaller volume than the cavity 9.

The base cavity 10 can contain a predetermined or metered amount of consumable. The height Hc of the base cavity 10 can be varied so that its capacity can be customised to the volume requirements of a particular consumable. The height Hc of the base cavity 10 therefore also provides an indication of when a correct amount of a consumable has been added to the cup 1. The cup 1 would typically contain drinkable consumables such as dried tea, coffee, etc., although other consumables can be contained.

As discussed above, the bellows 6 comprise a series of fold elements 14. FIG. 2b a section of the fold elements 14 in more detail. Each pair of fold elements 14 creating an outwardly extending fold 16 subtend an inner angle of 89.5°. Each pair of fold elements 14 creating an inwardly projecting annular trough 18 subtend an outer angle which is the same as the inner angle of the outwardly extending folds 16, i.e. 89.5°. An upper fold section 14 in a pair of fold elements 14 defining an inwardly projecting annular trough 18 makes an angle of 53.5° to an axis parallel to the longitudinal axis of the cup 1 whereas a lower fold section 14 of the pair makes an angle of 39.0° to the same axis. These angles have been found to be particularly conducive to a compact folding of the bellows 6 so that the volume occupied by the bellows 6 in the compressed state is greatly reduced. The outwardly extending folds 16 have a radius of curvature of 0.015 mm at their outer apex which helps release the cup from a mould during the manufacture of the cup and also results in a tight folding of the bellows, further reduced the size of the bellows in the compressed state.

FIG. 3a shows a cross-section through the cup 1 in the compressed state. The fold elements 14 are completely folded and are almost completely contained within the collar 5. Due to the taper of the sidewall 4 and the angle between the fold elements 14 each lower outwardly extending fold 16 and each lower inwardly projecting annular trough 18 folds within the respective outwardly extending fold 16 or inwardly projecting annular trough 18 above it. Consequently, the fold elements 14 fold in towards the centre of the cup 1 substantially within the space defined by the collar 5 resulting in a particularly compact and efficient folded configuration. This allows the cup 1 to be compressed more than if the bellows collapsed in a vertical configuration. The space within the base cavity 10 is maintained for containing the consumable. However, the additional space needed for the remainder of the cup 1 is greatly reduced. As a result, the volume which needs to be stored or transported is reduced and more cups can be transported or stored in a given space.

FIG. 3b shows the folded bellows 6 in more detail. A small radius of curvature for the connection between fold elements 14 means that the fold elements 14 can fold tightly together and abut each other so that there is no or little wasted space. The fold elements 14 align themselves parallel to each other and parallel to the uppermost and lowermost fold elements 14. Each lower outwardly extending fold 16 and each lower inwardly projecting annular trough 18 is arranged concentrically within the respective outwardly extending fold 16 or inwardly projecting annular trough 18 above it, i.e. the outwardly extending folds 16 and inwardly projecting annular troughs 18 are nested in the compressed state of the bellows 6. The bellows 6 extend inwardly into the cavity 9 in their compressed state in a direction transverse to the direction of the bellows in their uncompressed state and transverse to the direction in which the compressive force is applied. This is counter to a conventional bellows which fold in the direction of compression parallel to the direction in which the bellows extend in their uncompressed state. This configuration is achieved due to the taper of the sidewall 4 and by the angle subtended by the fold elements 14.

FIG. 4a shows the cup 1 in its compressed state and a closure 30 closing the opening 20. The closure 30 is attached to the lip 22 such that it forms an air-tight seal between the lip 22 and the closure 30, for example, by heat sealing. The closure is sealed to the cup 1 after a portion of consumable has been added to the cup 1 and when the cup 1 is in its fully compressed state.

The bellows 6 are elastic and resiliently act to urge the bellows 6 back to their uncompressed state. This reduces the pressure inside the cup 1. This creates a pressure differential between the outside of the cup 1 and the inside of the cup 1 with the pressure inside the cup 1 being lower than the ambient pressure outside the cup 1, i.e. a vacuum is created inside the cup 1. Air cannot enter the cup 1 due to the air-tight seal between the lip 22 and closure 30. Consequently, the ambient air pressure acting over the area of the closure 30 creates a retaining force which maintains the cup 1 in the compressed state.

FIG. 4b shows the closure 30 partly peeled away from a portion of the lip 22. Air is now able to enter the inner volume of the cup 1 and the pressure between the inside and outside of the cup 1 equalises. The resilience of the bellows causes them to expand unassisted and return to their uncompressed state. This increases the inner volume of the cup 1.

To provide the required resilience, the bellows are made from an elastic polymeric material. For ease of manufacture, the bellows 6 are generally made from the same material as the remainder of the cup 1, although different materials can be used. The cup 1 is made from a compound comprising 75-90% polypropylene or low density polyethylene (LDPE). To increase the resilient qualities of the bellows 6 a propylene based elastomer such as Vistamaxx™ manufactured by ExxonMobil Chemical can be added to the compound. The propylene based elastomer has added benefits in that it allows the wall thickness of the cup 1 to be reduced and increases the strength of the cup 1. The wall thickness of the cup 1 can be between 0.275-0.8 mm. The wall thickness of the lip 22 can be 0.250-0.8 mm. In addition, to make the cup 1 more impervious to oxygen, 3-6% of ethylene vinyl alcohol copolymer (EVOH) can be added to the compound to provide an oxygen barrier in order to extend shelf-life and preserve the consumable.

The closure is a laminate structure comprising a metal foil layer and a heat seal layer. The metal foil is made from aluminium and is approximately 70 micron in thickness. The heat seal layer is based on polypropylene and is approximately 25 micron in thickness. In addition, the closure can comprise an over-lacquer and be printed.

FIG. 5 shows a side elevation cross-section through a cup 101 according to a second embodiment of the invention. A region of the collar 105 below the lip 122 has an annular recess 124 which allows the cup 101 to be engaged or gripped by a machine on a production line. The cup 101 has an inwardly projecting depression 126 in its base 2 which forms a projecting rim 128 around the bottom of the base 2 which means that the cup 1 is supported more stably on uneven surfaces.

FIG. 6 shows a bowl 200 according to a third embodiment of the invention. The bowl 200 has a wider base 202 and opening (not shown) than cup 1 of FIGS. 1 to 4, which allows a user to eat from the bowl 200 as they would a standard china bowl using cutlery. The bowl 200 would typically be used to contain foodstuff consumables such as noodles, rice, porridge, etc., although other consumables can be contained.

FIG. 7 shows a bowl 300 according to a fourth embodiment of the invention. A region of the collar 305 below the lip 322 has an annular recess 324 which allows the bowl 300 to be engaged or gripped by a machine on a production line. The bowl 300 has an inwardly projecting depression 326 in its base 302 which forms a projecting rim 328 around the bottom of the base 302 which means that the bowl 300 is supported more stably on uneven surfaces.

The structural features of cup 101, bowl 200 and bowl 300 are the same as cup 1 in FIGS. 1 to 4. In particular, the sidewalls 104, 204 and 304 respectively of cup 101, bowl 200 and bowl 300 taper in the same manner as that of cup 1 and also the fold elements 114, 214 and 314 respectively of cup 101, bowl 200 and bowl 300 subtend the same angles as cup 1.

The cup 101, bowl 200 and bowl 300 can be provided with the same closure as provided for cup 1 (see FIG. 4) and functions in the same way as the cup 1. It can also be made from the same material and have the same wall thicknesses.

The containers, i.e. cup 1, cup 101, bowl 200 and bowl 300, can be used: i) for containing a consumable for storage, transportation and display; and ii) as a container for hydrating a consumable at the point of consumption. Both these uses will be described below with respect to cup 1 of FIGS. 1 to 4. However, the skilled person will appreciate that cup 101, bowl 200 and bowl 300 can be used in the same way.

To contain a consumable for storage, transportation and display, cup 1 is filled with a consumable. The cup 1 is held and compressed to its compressed state with a compressive force. A closure 30 is then sealed to lip 22 in order to provide an air-tight seal between the lip 22 and the closure 30. The compressive force can then be removed. As discussed above, due to the lower air pressure (partial vacuum) created inside the cup 1 by the bellows 6 trying to expand, the cup 1 is maintained in the compressed state, i.e. lower air pressure provides a retaining force which keeps the cup 1 compressed. The cup 1 is now ready to be stored, transport or displayed as required.

To use the cup 1 at the point of consumption, a user peels back closure 30 from at least a part of the lip 22 so that air can enter the inner volume of the cup 1. The cup 1 expands unassisted under the resilient action of the bellows 6 to its uncompressed state. The volume of the cup 1 in its uncompressed state is significantly greater than in its compressed. Water can be added to hydrate the consumable such that the uncompressed volume of the cup 1 can be used to produce the hydrated consumable.

FIG. 8a shows a cup 401 having a base 402 and a sidewall extending upwardly from the base 402. The base 402 and sidewall 404 define a cavity (not shown) inside the cup for containing a consumable. An upper portion of the sidewall 404 comprises a collar 405 which is not compressed in normal operation of the container. A lower portion of the sidewall 404 comprises a deformable sidewall element, which is generally concertina-shaped and forms a bellows-like structure 406.

The bellows-like structure 406 is deformable between an uncompressed state, as shown in FIG. 8a, and a compressed state, as shown in FIG. 8b. The bellows-like structure 406 is compressed through the supply of an activation energy by the application of a compressive force in a direction parallel to the longitudinal axis of the cup 401 towards the base 402. In the uncompressed state the bellows-like structure 406 has a height H3 corresponding to a first volume of the bellows-like structure. In the compressed state the bellows-like structure 406 has an effective height H4, which is less than height H3 and corresponds to a second volume of the bellows-like structure 406. The second volume of the bellows-like structure 6 is considerably less than the first volume. The reduction in volume will depend on the number of bellows.

The bellows-like structure 406 is stable in both the uncompressed state and the compressed state, i.e. the bellows-like structure 406 has bistability. This means that when the cup 401 is compressed it remains at rest in the compressed state without the need for any retaining force and when the cup 401 is in the uncompressed state it will remain in the uncompressed state without the need for a retaining force. This is achieved by means of an over centre mechanism comprised in the bellows-like structure 406 which is discussed in more detail below. The cup is able to return from the compressed state to the uncompressed and vice versa by input of an activation energy to the cup by a user, i.e. an input energy above a certain threshold value.

The bellows-like structure 406 comprises a series of fold-lines 412 in the material of the cup 401 which create a series of fold elements 414a and 414b. Pairs of fold elements 414a and 414b create a series of alternating outwardly extending folds 416 and inwardly extending folds 418. Each outwardly extending fold comprises an upper fold element 414a and a lower fold element 414b. The outwardly extending folds 416 and inwardly extending folds 418 are annular in shape.

As the bellows-like structure 406 is compressed towards the base 402, the fold elements 414a and 414b fold about the fold-lines 412 such that the angle between the fold elements 414a and 414b decreases and the height of the bellows-like structure 406 decreases. A portion of the bellows-like structure 406 may fold up inside the collar 5 (see FIG. 9b).

The sidewall 404 of the cup 401 tapers gently outwards as it extends away from the base 402. The sidewall 404 including the bellows-like structure 406 tapers such that each successive outwardly extending fold 416 is just wider, i.e. has a larger diameter, than the outwardly extending fold 416 below it such that each pair of fold elements 414a and 414b forming an outwardly extending fold 416 fits within the next pair of fold elements 414a and 414b forming an outwardly extending fold 416 above it, i.e. in a direction of increasing cross-section of the cup 401. Likewise, each successive inwardly extending fold 418 has a larger diameter than the inwardly extending fold 418 below it. As a result, successive pairs of fold elements 414a and 414b forming outwardly extending folds 416 are able to nest within the pair of fold elements 414a and 414b above it as the bellows-like structure 406 is collapsed (see FIG. 9b). The difference in diameters between the successive outwardly extending folds 416 and inwardly extending folds 418, and hence the taper of the cup 401, allows for the wall thickness of the folded material of the cup 401 and also various manufacturing tolerances.

An upper edge of the sidewall 404 of the cup 401 has a lip 422 extending transversely away from the collar 405. The lip 422 is smooth and the outer edge of the lip 422 curves upwards to assist a user in drinking from the cup 401. The cup 401 is circular in cross-section similar to the cup 1 shown in FIG. 1c or any conventional cup for that matter. However, other cross-sectional shapes may be used. The lip 22 provides an attachment surface for a closure (not shown). A region of the collar 405 below the lip 422 has an annular recess 424 which allows the cup 401 to be engaged or gripped by a machine on a production line. The cup 401 can be closed by a closure in a similar manner to the cup 1 shown in FIG. 4a or alternatively a screw-threaded closure could be used.

FIG. 9a shows a side elevation cross-section through a diameter of the cup 401 when in its uncompressed state. The sidewall 404 and the base 402 together define a cavity for containing a consumable. A first portion of the sidewall 404 comprising the collar 405 define a first portion 410 of the cavity and a second portion of the sidewall 404 comprising the bellows-like structure 406 define a second portion 409 of the cavity. When the cup 401 is in its uncompressed state as shown in FIG. 9a, the first portion 410 and second portion 409 of the cavity are suitable for containing a consumable in a usable condition, for example, once a volume of water has been added to a hydratable consumable to form a hydrated consumable such as a drink.

FIG. 9b shows a side elevation cross-section through a diameter of the cup 401 when in its compressed state. The volume of the second portion 409 of the cavity is reduced when the cup 401 is in its compressed state. When the cup 401 is in its compressed state as shown in FIG. 9b, the second portion 409 of the cavity, and the first portion 410 if required, are suitable for containing a consumable in its hydratable or dry form. The cup 401 would typically contain drinkable consumables such as dried tea, coffee, etc., although other consumables can be contained. A predetermined or metered amount of hydratable consumable can be contained in the cavity of the cup 401.

As discussed above, the bellows-like structure 406 comprises a series of fold elements 414a and 414b. Referring again to FIG. 9a, this shows that fold elements 414a and 414b are non-linear and in this particular embodiment of the invention the fold elements 414a and 414b are curved. In this document, non-linear is taken to mean that the cross-sectional shape of fold elements across their width extends a distance that is longer than a simple straight line joining the outwardly 416 and inwardly 418 extending folds. Shapes other than curves could be used. In the present embodiment, the fold elements 414a have a generally lazy S shape or lazy Z shape depending on the viewing perspective, i.e. they comprise two curves of roughly equal size which arc in opposing directions. The fold elements 414b have a lazy W-like shape, i.e. they comprise two curves which arc outwardly in the same direction. One of the curves of fold elements 414b is smaller than the other curve of fold elements 414b, i.e. the chord length of one of the curves is smaller than the other curve. The significance of the smaller curve is discussed further below. It will be appreciated that other shapes could be used.

Outwardly extending folds 416 are formed as small U-shaped ridges. These ridges extend outwardly from the cup 401 and around the entirety of the circumference of the cup, i.e. they are annular ridges. Due to their ridged shape, the outwardly extending folds 416 provide rigidity and stiffness to the cup 401, particularly in the plane of the annulus. The inwardly extending folds 418 are also formed as small ridges. Fold elements 414a and 414b which form each inwardly extending fold 418 are slightly spaced apart and joined by a small section of sidewall 404 to form a spacer 414c (see FIG. 12a). The ridges formed by the ends of fold elements 414a and 414b and spacer 414c extend inwardly into the cup 401 and around the entirety of the circumference of the cup, i.e. they are also annular ridges. Due to their ridged shape, the inwardly extending folds 418 also provide rigidity and stiffness to the cup 401, particularly in the plane of the annulus.

The curved fold elements 414a and 414b together with the outwardly 416 and inwardly 418 extending folds form an over centre mechanism which provides bistability to the bellows-like structure 406. In an over centre mechanism energy is imparted to the system in a first stable position to move it just past a peak at which point the mechanism goes “over centre” and moves to it to a second stable position. This creates a toggle-type action such that energy input to the system which is less than a certain threshold required to move the system from a stable position to the peak has no effect on the system, i.e. it remains in its current state, whereas energy input to the system which is more than a certain threshold moves the system from its current stable state to its other stable state.

FIG. 10a schematically illustrates one type of over centre mechanism. The over centre mechanism comprises two rigid uprights 502 and 504 which extend from a rigid base or substrate 506. The uprights 502 and 504 are spanned between their endpoints A and B by a curved element 508 which is made from a resilient material. In FIG. 10a the curved element 508 is in a first stable position in which it arcs away from the base 506 and the midpoint of the curved element 508 is in position X1. Curved element 508 is longer than the straight-line distance between points A and B.

A downwards force F is applied to the upper side of curved element 508. As shown in FIG. 10b, the curved element 508 starts to deform downwardly between the rigid uprights 502 and 504, i.e. work is done on or energy is imparted to the curved element 508. The amount of energy imparted to the curved element 508 increases as it is continues to deform downwardly under the application of force F until it reaches a peak at the line which joins points A and B. As soon as a threshold amount of curved element 508 has passed downwardly past the line joining points A and B, the curved element will snap to the stable configuration shown in FIG. 10c due to the resilience of the material which tends to urge it towards a stable configuration. In FIG. 10c the curved element 508 is in a second stable position in which it arcs towards the base 506 and the midpoint of the curved element 508 is in position X2.

The amount of energy required to move the curved element 508 from its first stable position in which the midpoint of the element is at point X1 to the point that it snaps past the line joining points A and B is called the activation energy. A similar amount of energy is required to move the curved element 508 from its second stable position in which the midpoint of the element is at point X2 back past the line joining points A and B.

This is more clearly illustrated in FIG. 11 which shows a graph of energy E against displacement X of the curved element 508. The energy of the system is at a minimum when the curved element is in either of it two stable states, i.e. when the midpoint of the element is at point X1 or X2. Increasing amounts of energy need to be imparted to the system to move the curved element 508 from point X1 towards the line joining points A and B. This energy is stored as potential energy in the curved element 508. The energy of the system reaches a maximum or peak at the line joining points A and B. The amount of energy required to displace the curved element from point X1 to the line joining points A and B represents the activation energy, Ea. As soon as the curved element 508 moves beyond the line joining points A and B, the potential energy stored in the curved element 508 causes it to snap to its second stable position in which the midpoint of the element is at point X2 and the curved element gives up its potential energy to once again resume a minimum energy state.

Of course, it will be appreciated that FIGS. 10a-c illustrate only one type of over centre mechanism. Numerous other configurations would be within the contemplation of the skilled person. For example, instead of rigid uprights, resilient flexible uprights could be used which would deform outwards as the curved element is depressed.

FIGS. 12a and 12b show in enlarged section the over centre mechanism used in the bellows-like structure 406 of the cup 401 in the uncompressed state and compressed state respectively of the described embodiment. Referring firstly to FIG. 12a, fold elements 414a have a generally lazy S shape and comprise curves 414a(i) and 414a(ii). Fold elements 414b have a W-like shape and comprise curves 414b(i) and 414b(ii). Curve 414b(ii) is smaller than curve 414b(i), i.e. curve 414b(ii) has a geometrically smaller chord length. As discussed above, outwardly extending folds 416 and inwardly extending folds 418 are formed as annular ridges which give rigidity to the bellows-like structure 406 in the plane of the rings. The outwardly extending folds 416 and inwardly extending folds 418 therefore act like the rigid uprights 502 and 504 in FIG. 10a-c. A compressive force towards the base 402 has to be applied to the cup 401 in a direction parallel to the longitudinal axis of the cup 401 in order to compress it. This force is transmitted through the sidewall 404 to the bellows-like structure 406. The fold elements 414a and 414b are pinned between the rigid ridges of the outwardly extending folds 416 and inwardly extending folds 418. As curve 414b(ii) of the W-shaped fold element 414b is smaller than the other curves, force is concentrated in this curve and as the bellows-like structure is compressed increasing amounts of energy are imparted to curve 414b(ii) which, upon reaching the activation energy threshold snaps over centre to a second stable configuration in which it arcs in the opposite direction (see FIG. 12b). The other curves, i.e. curves 414a(i), 414a(ii) or 414b(i) have not changed their direction of arc. As a result, fold element 414b now also assumes a generally lazy S shape. Due to the over centre movement of curve 414b(ii) and also the compression of the cup 401, fold element 414b angles upward so that it nests within the adjacent fold element 414a above it. Fold element 414b will rest stably in equilibrium in this configuration until an expanding force is applied to the cup 401 and sufficient activation energy is imparted to 414b(ii) to cause it to arc back to its uncompressed configuration.

By the time the cup 401 reaches its fully compressed state all of curves 414b(ii) of all the fold elements 414b of the bellows-like structure will have moved over centre to arc in the opposite direction and the bellows-like structure will adopt the configuration shown in FIG. 12b. As shown in FIG. 12b, each of fold elements 414b now nest within the adjacent fold element 414a above it. The spacer 414c located at the inwardly extending folds 418 provide additional room for the fold elements 414b to nest within the adjacent fold element 414a above it. The cup 401 will rest stably in equilibrium in the compressed configuration shown in FIG. 12b. The over centre mechanism incorporated in the bellows-like structure 406 is sufficient to resist any urge to return to the uncompressed state due to the potential energy stored in the compressed bellows-like structure 406 as a result of any resilience in the material from which the sidewall 404 is made.

If an opposite expansive force away from the base is applied to the cup 401 in a direction parallel to the longitudinal axis of the cup 401, the above process will happen in reverse and the cup 401 will return to its uncompressed configuration in FIG. 12a in which it will rest stably in equilibrium. The resilience of the sidewall 404 can be adjusted so that either a user has to fully expand the cup 401 to its uncompressed state or only has to apply enough energy to move a few of the curves 414b(ii) over centre, after which a chain reaction occurs and the cup 401 returns to it fully uncompressed state of its own accord due to increased resilience of the sidewall material.

The activation energy required to move the curves 414b(ii) over centre is designed to be easily achievable by an average user and is typically that which can be applied by hand. For example, a user can grasp the collar 405 and base 402 between thumb and fingers of each hand and the cup 401 can be compressed or expanded with minimal strength due to the design which concentrates the force applied in curve 414b(ii). A user can tell as each curve moves over centre because they will hear a clicking sound.

FIG. 13 shows a cup 501 according to a second embodiment of the invention. The cup 501 has an inwardly projecting depression 526 in its base 502 which forms a projecting rim 528 around the bottom of the base 502 which means that the cup 501 is supported more stably on uneven surfaces. The skilled person will appreciate that the principles of the invention can be applied to other types of container such as bowls and bottles and that such containers will also fall within the scope of the claims.

In one embodiment, the cup 401 is produced by means of injection stretch blow moulding. This is a two-part process. Firstly, a plastics preform having the collar 405, lip 422 and base 402 features is fabricated by injection moulding. Secondly, the preform is placed into a further mould where it is heated to make the plastics more pliable and compressed air is blown into the mould in order to blow mould the bellows-like structure 406. This two-part process allows the wall thickness of different parts of the cup 401 to be controlled. The injection moulding step can be used to give the collar, lip and base a thicker wall thickness, whereas, the blow moulding step stretches the plastic to conform to the mould resulting in a reduced wall thickness and rigidity of the bellows-like structure 406. The wall thickness of the collar 405 of the cup 401 can be between 0.6 and 1.0 mm. The same thicknesses can also be applied to the base 402 and lip 422. The wall thickness of the bellows-like structure 406 of the cup 401 can be between 0.1 and 0.3 mm. In one embodiment, the wall thickness of the collar 405 of the cup 401 is 0.8 mm and the wall thickness of the bellows-like structure 406 is 0.2 mm. Of course, it will be appreciated that thicker or thinner wall thickness can be used. The wall thickness also affects the resilience of the bellows-like structure, with a thicker wall thickness generally resulting in a more resilient structure. The wall thickness ultimately depends on the thickness given to different parts of the preform when the preform is fabricated and this can be controlled during the injection moulding process. The same manufacturing process and properties can also be applied to the cup 501.

The cups 401 and 501 are generally made from a plastics material and can be used to contain both hot and cold products. For hot products, polypropylene is the preferred material. For cold or room temperature products, polyethylene terephthalate or PET is the preferred material. However, it will be appreciated that other materials can be used. Furthermore, additives may be added to the cup material to adjust its properties such as resilience or colour, etc.

A container according to the invention, i.e. cups 401 and 501, can be used: i) for containing a consumable for storage, transportation and display; and ii) as a container for hydrating a consumable at the point of consumption. Both these uses will be described below with respect to cup 401. However, the skilled person will appreciate that cup 501 or any other container according to the invention can be used in the same way.

To contain a consumable for storage, transportation and display, cup 401 is firstly compressed to its compressed state. As the cup 401 stably remains in the compressed state of its own accord there is no need to apply a retaining force. The cup 401 is then filled with a consumable. Alternatively, the cup 401 could be filled with a consumable before it is compressed. Once the container has been compressed and filled a closure is applied to the opening in order to seal the consumable within the cup 401. The cup 1 is now ready to be stored, transported or displayed as required.

To use the cup 401 at the point of consumption, a user removes the closure in order to gain access to the consumable and prevent a vacuum forming when they try to expand the cup 401. The user gently pulls the collar 405 or lip 422 away from the base to cause at least a few of the curves 414b(ii) of the bellows-like structure 406 to move over centre. Depending on the degree of resilience that has been incorporated in the material, the cup 401 with then either return to the uncompressed state of its own accord due to the potential energy stored in the bellows-like structure or a user can pull the cup 401 to its fully uncompressed state. The volume of the cup 401 in its uncompressed state is significantly greater than in its compressed volume. Water can then be added to hydrate the consumable such that the uncompressed volume of the cup 401 can be used to produce the hydrated consumable.

As used herein any reference to “one embodiment” or “an embodiment” means that a particular element, feature, structure, or characteristic described in connection with the embodiment is included in at least one embodiment. The appearances of the phrase “in one embodiment” or the phrase “in an embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

In view of the foregoing description it will be evident to a person skilled in the art that various modifications may be made within the scope of the invention. A container may be provided which does not have a base cavity and which is not intended to contain a consumable so that the container can be compressed to an even greater extent, i.e. to a virtually flat shape. Such a container would provide a means of saving space where space is at a premium and may find application in hotel and hostels, on ships, for camping or in the military.

The container may have a secondary lid in order to protect the closure. The container may be made from a heat resistant material, i.e. a material which is able to withstand temperatures of up to 100° C. (the boiling point of water at sea level) without loss of structural strength or integrity to allow for the preparation of hot drinks and foodstuffs. Furthermore, the container may be configured so that it is microwave and freezer safe. The container may be made from a material which is able to withstand temperatures in excess of 100° C. to allow food and drinks to be cooked in the container in a microwave. In addition, the container may be configured so that it is recyclable.

Various different materials may be suitable for the container. For example, the container can be made out of waxed or coated cardboard or other coated fibrous materials, although polymers are generally preferred due to their advantageous properties. For example, the container including the bellows may be made from one or more materials selected from the following list: Thermoplastic Urethane; Polypropylene; Random & Block Copolymer; Homo Polymer; Low Density Polyethylene (LDPE); High Density Polyethylene (HDPE); Linear Low Density Polyethylene (LLDPE); Thermoplastic Elastomers (TPE); Thermoplastic Ethylene (TPE); Thermoplastic Olefins (TPO). Furthermore, various different additives for providing the elastic and oxygen barrier properties of the container may be used. The elasticity of the container is dependent on the particular mix of materials used. The elasticity has been found to be generally related to the density of the material mix used. A density of 0.923 g/cm³ has been found to be particularly suitable. In addition, tie layers may be used. These are melt layers which help other laminates or additives such as EVOH to bond to the other polymers.

Various different materials may also be suitable for the closure. For example, the closure does not need to comprise a metal foil. A closure comprising only a polymeric film such as polypropylene or LDPE may also be used.

Although the specific description refers to the fold elements 14 being aligned in parallel when the bellows 6 are compressed, the term “parallel” is not used in a strict geometric sense and compliance with a strict geometric meaning is not intended or necessary for an embodiment of the invention.

Embodiments have been described using air as the gas in the container when compressed. However, the ordinarily skilled person would recognise that an inert gas, such as nitrogen, may be introduced into the container to create a substantially nitrogen atmosphere in the container albeit at a lower pressure than ambient atmospheric pressure.

Although a specific embodiment in accordance with the invention has been described utilising ridges, particularly U-shaped ridges, forming the outwardly and inwardly extending folds, embodiments in accordance with the invention may use different shaped ridges, ridges on just one or other of the outwardly and inwardly extending folds, or no ridges at all.

The scope of the present disclosure includes any novel feature or combination of features disclosed therein either explicitly or implicitly or any generalisation thereof irrespective of whether or not it relates to the claimed invention or mitigate against any or all of the problems addressed by the present invention. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

In addition, the order of the various elements of the independent method claim does not imply that the elements have to be carried out in any particular order. For the avoidance of doubt, the container can either be compressed and then the consumable placed in the container or the consumable can be placed in the container and then the container compressed.

1. A container comprising:
a base; and
a sidewall extending from the base;
wherein the base and the sidewall define a cavity for containing a consumable;
the sidewall comprising at least in part a sidewall element deformable between a compressed state in which the cavity has a first volume and an uncompressed state in which the cavity has a second volume;
the sidewall element configured to be bistable such that the sidewall element will remain at rest in equilibrium in both the compressed state and the uncompressed state;
wherein the sidewall element is movable between the compressed and uncompressed states by input of an activation energy to the container.

2. A container according to claim 1, wherein the sidewall element is compressible so that the height of the container is reduced in the compressed state compared to the uncompressed state.

3. A container according to claim 2, wherein the sidewall element is axially compressible.

4. A container according to any of claims 1 to 3, wherein the bistability is provided by the sidewall element comprising an over centre arrangement.

5. A container according to any preceding claim, wherein the sidewall element comprises a bellows-like structure, the bellows-like structure comprising alternating inwardly extending folds and outwardly extending folds connected by fold elements.

6. A container according to claim 5, wherein the bellows-like structure comprises the over-centre mechanism.

7. A container according to claim 6, wherein the over-centre mechanism comprises at least one pair of adjacent fold elements of the bellows-like structure which are non-linear.

8. A container according to claim 7, wherein the at least one pair of adjacent fold elements of the bellows-like structure are curved.

9. A container according to claim 8, wherein the curve of one of the curved fold elements of the at least one pair of adjacent fold elements has a shorter chord length than the curve of the other one of the curved fold elements of the at least one pair of adjacent fold elements.

10. A container according to claim 9, wherein the one of the curved fold elements of the at least one pair of adjacent fold elements having a curve of shorter chord length is substantially W-shaped and the other of the curved fold elements of the at least one pair of adjacent fold elements has a substantially lazy S shape.

11. A container according to any of claims 5 to 10, wherein adjacent pairs of fold elements forming the outwardly extending folds are spaced apart at the inwardly extending folds.

12. A container according to any of the preceding claims, wherein the sidewall is movable between the compressed state and uncompressed state by manually applied activation energy and vice versa.

13. A container according to any of claims 1 to 11, wherein a resilience of the sidewall element is configured such that the container automatically returns to its uncompressed state from its compressed state following input of an initial activation energy to the container.

14. A container according to any of claims 1 to 12, wherein a resilience of the sidewall element is configured such that further energy has to be applied to the container to return the container to its uncompressed state from its compressed state following input of an initial activation energy to the container.

15. A container according to any of the preceding claims, wherein the sidewall comprises first and second portions which define first and second portions of the cavity respectively, wherein the first portion of the sidewall is not compressible during normal operation of the container and wherein the second portion of the sidewall comprises the sidewall element.

16. A container according to claim 15, wherein the first portion of the sidewall is located near an edge of the sidewall opposite the base.

17. A container according to claim 15 or 16, wherein the first portion and second portion have different wall thicknesses.

18. A container according to claim 17, wherein the wall thickness of the first portion is thicker than the wall thickness of the second portion.

19. A container according to claim 17 or 18, wherein the wall thickness of the first portion is between 0.6 and 1.0 mm.

20. A container according to any of claims 17 to 19, wherein the wall thickness of the second portion is between 0.1 and 0.3 mm.

21. A container according to any preceding claim, wherein an edge of the sidewall opposite the base defines an opening, the container further comprising a closure for closing the opening.

22. A method of manufacturing a container according to any one of the preceding claims, the method comprising:
forming a preform by injection moulding; and
blow moulding at least a part of the preform to produce the container.

23. A method according to claim 22, wherein the preform forming step comprises injection moulding a first portion of a sidewall of the container, the first portion of the sidewall not being compressible during normal operation of the container.

24. A method according to claim 22 or 23, wherein the preform forming step further comprises injection moulding the base of the container.

25. A method according to any of claims 22 to 24, wherein the blow moulding step comprises blow moulding the preform to form a second portion of the sidewall, the second portion of the sidewall comprising a sidewall element which is deformable between a compressed state and an uncompressed state.

26. A method according to claim 25, wherein the blow moulding step comprises blow moulding a bellows-like structure.

27. A method according to claim 25 or 26, wherein the method comprises forming the first and second portions of the sidewall with different sidewall thicknesses.

28. A method of containing a consumable, the method comprising:
providing a container according to any one of the preceding claims;
compressing the container so that the container adopts a compressed state;
placing a predetermined amount of a consumable in the container;
closing the container with a closure.

29. A method of containing a consumable according to claim 28, wherein the method is immediately preceded by the method steps of claims 22 to 27 such that the methods of claims 22 to 28 are carried out as part of a single continuous production process.

30. A container substantially as herein described with reference to, and as illustrated in, the accompanying figures.
